(19) United States
(12) Patent Application Publication
(10) Pub. No.: US 2011/0268112 A1
(43) Pub. Date: Nov. 3, 2011

(54) ETHERNET MODULE HAVING A REDUCED HOST PCB FOOTPRINT AND DIMENSIONED TO CORRESPOND TO A REAR FACE OF AN RJ CONNECTOR JACK

(75) Inventor: Dmitry Slepov, Taipei Hsien (TW)

(73) Assignee: TIBBO TECHNOLOGY INC., Taipei Hsien (TW)

(21) Appl. No.: 12/769,055

(22) Filed: Apr. 28, 2010

(51) Int. Cl. H04L 12/56; H01R 13/40

(52) U.S. Cl. 370/389; 439/76.1

(57) ABSTRACT

The present invention provides an Ethernet module for a finished Ethernet device, said finished Ethernet device comprising: a host circuit board, and a connector jack mounted upon said host circuit board; wherein said Ethernet module comprises a circuit board vertically mountable upon the host circuit board, and wherein said Ethernet module is dimensioned to correspond to a rear face of said connector jack. By the innovative construction of space-saving Ethernet module, the present invention reduces the footprint of the Ethernet module on the host circuit board and increases the efficiency of utilization of the finished Ethernet device's internal volume.

### BACKGROUND OF THE INVENTION

1. Field of the Invention

This invention relates generally to Ethernet modules, including serial-to-Ethernet converter modules and programmable Ethernet modules. More particularly, this invention relates to an innovative construction of a space-saving Ethernet module occupying reduced area on a host circuit board of a finished Ethernet device and dimensioned to correspond to a rear face of a regular RJ connector jack.

2. Description of the Prior Art

Ethernet modules are well known in the industry. Such modules are used both in the design of new products, as well as for retrofitting existing products with the Ethernet interface.

Ethernet modules are often said to “network-enable” their host products, meaning that the Ethernet module built into the host product gives the latter a network interface (in the form of the Ethernet interface). For the purpose of clarity, a host product incorporating an Ethernet module will hereinafter be referred to as a finished Ethernet device.

Within the category of Ethernet modules, serial-to-Ethernet converter modules are extremely popular. The reason for this is that most products requiring network enablement have a CPU or microcontroller, and the majority of CPUs and microcontrollers are equipped with universal asynchronous receiver/transmitter (UART) circuits used for serial communications.

A serial-to-Ethernet converter module allows to quickly and inexpensively network-enable such a CPU or microcontroller-equipped product by seamlessly converting between serial and Ethernet (TCP/IP) data.

Another type of Ethernet modules will be referred to as programmable Ethernet modules. Such modules allow a developer to load a custom software program (application) into the module. The module can then serve as an intelligent processing block of the finished Ethernet device, thus offloading the main CPU or microcontroller of said device, or even completely eliminating the latter.

For the purposes and goals of the present invention, the term “Ethernet module” will equally apply to all categories of such modules including serial-to-Ethernet converter modules and programmable Ethernet modules.

A simplified block diagram of a typical Ethernet module and a finished Ethernet device incorporating such module are shown on FIG. 1.

The Ethernet module 10 is typically installed on a host circuit board (not shown) of the finished Ethernet device 11. Said Ethernet module 10 incorporates a CPU or microcontroller 12, data bus 13, an Ethernet controller 14, and other hardware 15. Said other hardware 15 may include RAM, flash memory, and other peripherals required for the operation of the Ethernet module 10. The precise set of such peripherals is immaterial to the scope and spirit of the present invention.

It is noteworthy, that some CPUs and microcontrollers on the market today incorporate Ethernet controllers, so blocks 12 and 14 may be realized as a single integrated circuit, with the data bus 13 existing within said integrated circuit.

The Ethernet module 10 has a number of pins (leads) 16 through which it is coupled to other components on the host circuit board and/or finished Ethernet device 11. Specifically, the Ethernet module 10 is coupled to an RJ connector jack 17, Ethernet status LEDs 20, module status LEDs 26, as well as external (with respect to the Ethernet module 10) hardware 22.

The Ethernet controller 14 and the RJ connector jack 17 are linked by receive (Rx) and transmit (Tx) line pairs 18. In addition, there are Ethernet status LED control lines 19 that drive Ethernet status LEDs 20 of the RJ connector jack 17.

The Ethernet status LEDs 20 are typically used to indicate the current link status and link mode of the Ethernet controller 14. Of the two said LEDs, one is typically of green color, and another one is typically of yellow color.

Although only two single-color Ethernet status LEDs 20 are shown, it is understood that there could be more LEDs and (or) multi-color LEDs built into the RJ connector jack 17. Alternatively, the Ethernet status LEDs 20 may be implemented separately from said RJ connector jack 17, or not implemented at all. All such variations are immaterial to the scope and spirit of the present invention.

The Ethernet module 10 and the external hardware 22 are linked by input/output (I/O) lines 21. In some cases, said external hardware 22 includes only simple non-intelligent components such as relays, opto-isolated inputs, analog-to-digital converters (ADC) or digital-to-analog converters (DAC). These non-intelligent components are then controlled by the CPU or microcontroller 12.

In other cases, the external hardware 22 may comprise a second CPU or microcontroller 23, which is often the main (“master”) CPU or microcontroller of the finished Ethernet device 11.

The I/O lines 21 can be implemented in a multitude of ways and employ interfacing techniques suitable for a particular set of external hardware 22. Said I/O lines 21 may comprise simple digital input/output lines, ADC and DAC lines, pulse-width modulated (PWM) signal lines, and so on.

If the external hardware 22 comprised the second CPU or microcontroller 23, I/O lines 21 often comprise serial port lines. In this case, the CPU or microcontroller 12 and the second CPU or microcontroller 23 use serial communications to interact with each other.

It must be noted that in the majority of designs such serial communications conform to the timing of RS232 interface, but physical lines are of a CMOS or TTL type. Most modern CPUs and microcontrollers include one or more UART blocks 24, so it is possible to interconnect the UARTs 24 of the CPU or microcontroller 12 and the second CPU or microcontroller 23 directly, without any additional “glue” components.

Other serial port arrangements are possible. For example, the CPU or microcontroller 12 may not include or use the UART 24. Instead, the other hardware 15 may include such an UART. The same applies to the second CPU or microcontroller 22. All such variations are immaterial to the spirit and scope of the present invention.

The Ethernet module 10 often includes a number of module status LED control lines 25 for driving a set of module status LEDs 26 used for indicating the current status of the Ethernet module.

The function of module status LEDs 26 is not to be confused with the function of Ethernet status LEDs 20. Ethernet status LEDs 20 display the current link status and link mode of the Ethernet controller 14. Module status LEDs 26 provide indication of the overall state of the Ethernet module 10.

For example, module status LEDs 26 may indicate that the Ethernet module 10 is idle, or running in the setup mode, or has established a TCP/IP link with another device on the network, and so on.

Physically, a typical Ethernet module may be implemented, for example, as a circuit board incorporating pins or leads for mounting on the host circuit board of the finished Ethernet device. A simplified drawing of such module is shown on FIG. 2.

The Ethernet module 10 characteristically comprises a circuit board 100, which is generally parallel to the host circuit board (not shown) upon which said circuit board 100 is installed. The circuit board 100 has two opposing sides 101 and 102 and both sides may be used for mounting electronic components.

FIG. 2. shows two such components: the CPU or microcontroller 12, and the Ethernet controller 14. The circuit board 100 typically includes other hardware as well (not shown). Two rows of pins (leads) 16 connect the Ethernet module 10 to the host circuit board. Pins (leads) of thru-hole type are shown, but SMT and pins (leads) of other shapes may be used.

The Ethernet module 10 may include a housing or enclosure (not shown) that at least partially covers the circuit board 100 for decorative, protective, or heat dissipation purposes.

For the purposes and goals of the present invention, the term “Ethernet module” will equally apply to Ethernet modules without the enclosure and Ethernet modules with enclosures.

There are numerous other variants of physical implementation of the Ethernet module. For example, U.S. Pat. No. 6,881,096, discloses an Ethernet module incorporated directly into an RJ connector jack.

Construction of a typical RJ connector jack 17 is of special importance to the present invention.

RJ connectors are commonly used in telecommunications, data networking equipment, and devices having an ability to connect to data networks. RJ connectors employ a male connector plug and a female connector jack.

For finished Ethernet devices, the female connector jack is typically mounted on the network-enabled device and is exposed in such a way as to allow the insertion of the male connector plug. A simplified drawing of a typical connector jack is shown on FIG. 3.

RJ connector jack 17 characteristically comprises a generally rectangular dielectric housing 200, said housing 200 having a front face 201 with a receptacle 202 for receiving the male connector plug (not shown), and a bottom face 203 adopted for mounting on the host circuit board (not shown). The housing 200 also defines a right face 204, left face 205, rear face 206, and a top face 207.

The front face 201 often includes or exposes a pair of Ethernet status LEDs 20.

The receptacle 202 includes latching shoulders 208 which, in conjunction with the latching shoulder on the plug (not shown), form a mechanism for reliable engagement between the plug and the jack.

The RJ connector jack 17 also incorporates pins or leads 209. These pins or leads conduct electrical signals between the jack and the host circuit board.

Many RJ connector jacks also have a Faraday shield 210 that envelops the housing 200. Said shield 210 often has spring biased grounding tabs 211 located on the left right face 204, right left face 205, and top face 207. Said grounding tabs 211 connect the Faraday shield to chassis (Earth) ground by contacting the enclosure of the finished Ethernet device. Grounding tabs protrude from the right, left, and top faces of the jack and slightly increase effective jack dimensions.

One inescapable fact of the RJ connector jack's construction is that its height 211 and width 212 can't be reduced substantially, even as rapid technical progress has led to a dramatic miniaturization of other electronic components. This is because the male connector plug has standard dimensions that dictate the minimum possible dimensions of the jack.

Several attempts has been made to somewhat decrease the overall dimensions of the RJ connector jack. Most of these attempts have concentrated on decreasing the height 211 of the jack. For example, U.S. Pat. No. 4,497,526 discloses a jack of reduced height, and the height reduction is achieved by moving the latching mechanism off the jack and onto the bottom side of the housing of the finished Ethernet device.

U.S. Pat. No. 5,378,172 discloses a low-profile jack, in which the reduction in the jack height is achieved by delegating the latching function of the jack to the host circuit board.

It must be noted that the above improvements have only had a marginal effect on the industry and the majority of RJ connector jacks are still built in the image of the jack shown on FIG. 3. The market has even produced a de-facto “standard” for the RJ connector jack's dimensions. Accounting for tolerances and excluding grounding tabs 210, this de-facto standard sets the height 211 at approximately 14 mm, and the width 212 at 16 mm. Including the grounding tabs 210, the “standard” height 211 is around 15 mm, and the “standard” width 212 is around 17.5 mm. An overwhelming number of RJ connector jacks manufactured today have the above width and height.

Since most RJ connector jacks have a “standard” height, this often dictates the height of the finished Ethernet device incorporating RJ connector jacks. Taking into account that most modern electronic components are low-profile, this leaves RJ connector jack “towering high” above the rest of the electronic circuits. A large portion of the finished Ethernet device's internal volume, typically behind the RJ connector jack, is then left unused.

Continuous miniaturization of electronic devices demands an ever-increasing density of component placement on printed circuit boards. As network-enabled electronic devices shrink in size, the pressure is placed on the manufacturers of Ethernet modules to reduce the footprint occupied by said modules on host circuit boards.

This happens at a time when Ethernet modules are starting to hit a “size reduction ceiling”, with some modules being barely large enough to fit a single integrated circuit incorporating the CPU or microcontroller, the Ethernet controller, memory, UART(s) and almost all other components necessary for module's operation.

### SUMMARY OF THE INVENTION

In view of the above, it is an object of the present invention to reduce the footprint of the Ethernet module on the host circuit board. It is another object of the present invention to increase the efficiency of utilization of the finished Ethernet device's internal volume.

The present invention provides an Ethernet module for a finished Ethernet device, said finished Ethernet device comprising: a host circuit board, and a connector jack mounted upon said host circuit board; wherein said Ethernet module comprises a circuit board vertically mountable upon the host circuit board, and wherein said Ethernet module is dimensioned to correspond to a rear face of said connector jack.

In the preferred embodiment of the present invention, the circuit board of the Ethernet module is not oriented in a generally parallel fashion with respect to the host circuit board. In the preferred embodiment of the present invention, said circuit board is oriented in a generally perpendicular fashion with respect to the host circuit board.

According to the preferred embodiment of the present invention, the Ethernet module uses an integrated circuit that contains the CPU or microcontroller, the Ethernet controller, memory, UART(s), and I/O lines. Said integrated circuit is mounted upon a first side of the Ethernet module's circuit board.

It is envisioned that a second side of the Ethernet module's circuit board is occupied by small(er) components that are typically necessary to complete the circuit of the Ethernet module.

It is further envisioned that the second side of the Ethernet module's circuit board contains a connector comprising pins or leads that are generally parallel to the circuit board of the Ethernet module and generally perpendicular to the host circuit board. Said pins or leads are used to install the Ethernet module on the host circuit board and conduct electric signals between the Ethernet module and the host circuit board.

According to the preferred embodiment of the present invention, the height and width of this innovative Ethernet module can be made to not exceed, or only slightly exceed the “standard” width and height of the RJ connector jack when said height and width account for grounding tabs.

It is envisioned that the Ethernet module of the present invention will be mounted on the host circuit board directly behind the RJ connector jack. Having the height and width dimension to correspond to the rear face of the RJ connector jack, the innovative Ethernet module will utilize the internal space of the finished Ethernet device in a highly efficient manner.

Namely, the innovative Ethernet module will occupy a very small space on the host circuit board, and utilize an empty space typically available behind the RJ Ethernet jack.

In the alternative embodiment of the present invention, the Ethernet module does not use an integrated circuit packaged in a standard housing with leads. In the alternative embodiment of the present invention, the Ethernet module utilizes a chip-on-board technology to mount one or more silicon dies upon the first and the second sides of the Ethernet module's circuit board.

Other objects, features and advantages of the present invention will be apparent from the following detailed description taken in connection with the accompanying drawings.

### BRIEF DESCRIPTION OF THE DRAWINGS

FIG. 1 is a simplified block diagram of a typical Ethernet module according to the prior art and a finished Ethernet device based on said Ethernet module.

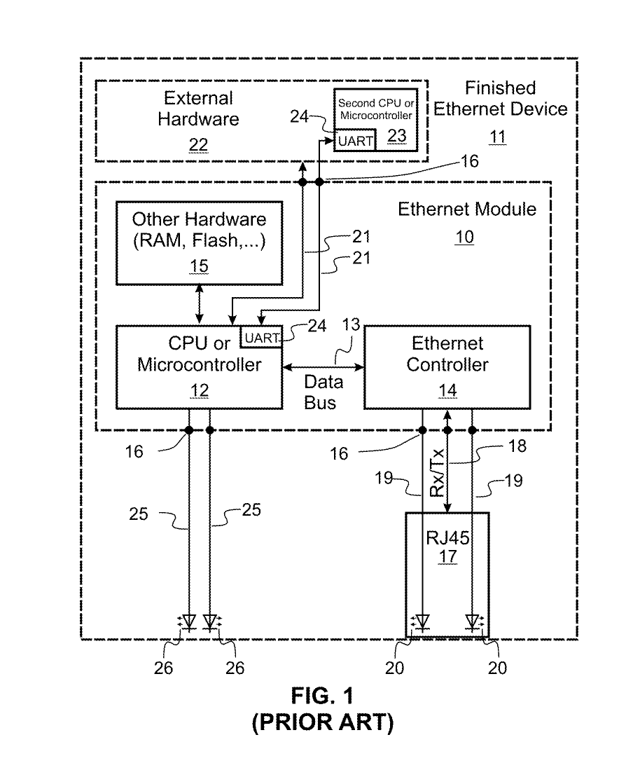

FIG. 2 is a simplified drawing of a typical Ethernet module according to the prior art.

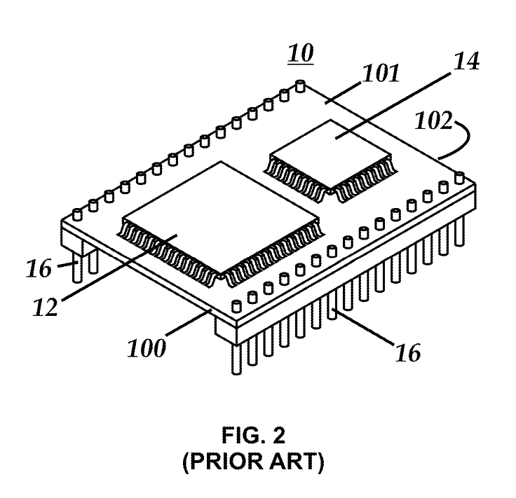

FIG. 3 shows a simplified construction of a typical RJ connector jack according to the prior art.

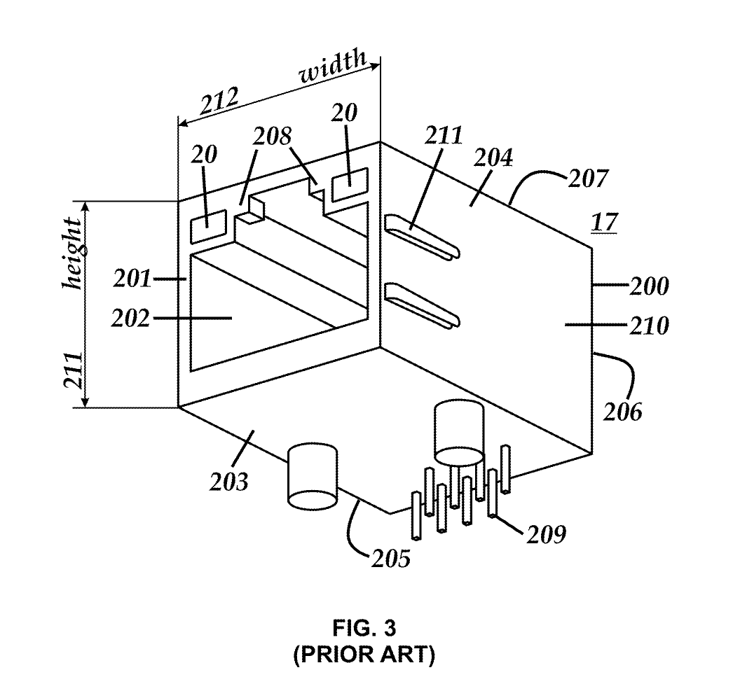

FIG. 4 is a drawing of the Ethernet module according to the preferred embodiment of the present invention.

FIG. 5 is a drawing of a host circuit board, a “standard” RJ connector jack, and the Ethernet module according to the preferred embodiment of the present invention mounted behind said RJ connector jack.

FIG. 6 is a drawing of the Ethernet module according to the alternative embodiment of the present invention.

### DETAILED DESCRIPTION OF THE PREFERRED EMBODIMENTS

In the following detailed description, reference is made to the accompanying drawings that form a part thereof, and in which are shown by way of illustration, specific embodiments in which the invention may be practiced.

The embodiments of the present invention are described in sufficient detail to enable those skilled in the art to practice the invention, and it is to be understood that other embodiments may be utilized. It is also to be understood that changes can be made without departing from the spirit and scope of the present invention. The following detailed description, therefore, is not to be taken in the limiting manner, and the scope of the present invention is defined by the following claims and their equivalents.

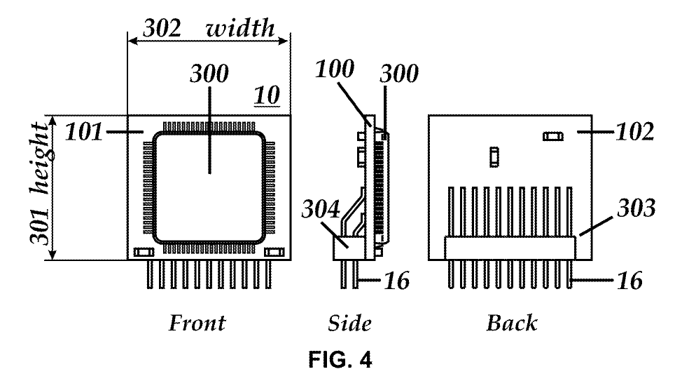

Referring to FIG. 4-6, the embodiments of the present invention are shown.

Referring particularly to FIG. 4, there shown a front, side, and back views of the Ethernet module according to the preferred embodiment of the present invention.

The Ethernet module according to the preferred embodiment of the present invention is realized using an integrated circuit 300, which incorporates the CPU or microcontroller and the Ethernet controller. The integrated circuit may also incorporate flash memory for storing the program (firmware) of the CPU, SRAM for storing variables and data, general I/O lines, and UART(s).

An example of the integrated circuit 300 is an LM3S8930 part from Luminary Micro (currently owned by Texas Instruments). This integrated circuit incorporates all blocks listed above. The circuit is available in a 100-pin LQFP package with outline dimensions of 16×16 mm or 108-ball BGA package with outline dimensions of 10×10 mm.

According to the preferred embodiment of the present invention, the integrated circuit 300 is mounted upon the first side 101 of the circuit board 100 of the Ethernet module 10. The first side 101 of the circuit board 100 may or may not have other electronic parts mounted atop said first side.

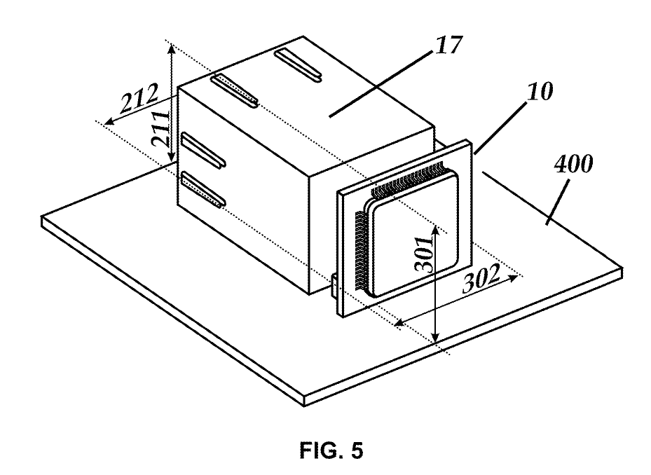

Looking at FIG. 5 those skilled in the art will recognize that the height 301 and width 302 of the circuit board 100, and, hence, the overall height and width of the Ethernet module 10 constructed according the preferred embodiment of the present invention, are dictated largely by the outline dimensions of the integrated circuit 300.

For the 100-pin LQFP package with outline dimensions of 16×16 mm, the height 301 and width 302 of the circuit board 100 can be made as small as 17×17 mm. This only marginally exceeds the “standard” height 211 and width 212 of the RJ connector jack (including the spring tabs). Thus, according to the preferred embodiment of the present invention, although the height 301 and width 302 may be larger than the respective height 211 and width 212 of the RJ connector jack, the difference in corresponding dimensions is small and will not substantially increase the height and width of the finished Ethernet device.

If the 108-ball BGA package is used, the overall dimensions of the circuit board 100 can be further substantially reduced and become smaller than corresponding dimensions of the RJ connector jack. Thus, according to the preferred embodiment of the present invention, the height 301 and width 302 may be smaller than the respective height 211 and width 212 of the RJ connector jack.

In both cases, the dimensions of the Ethernet module 10 can be achieved by choosing a fitting package for the integrated circuit 300 and dimensioning the circuit board 100 to have a height and width either substantially equal to the respective height and width of the RJ connector jack, or smaller than the respective height and width of the RJ connector jack, or larger than the respective height and width of the RJ connector jack without substantially increasing the height and width of the finished Ethernet device.

It must be noted that the particular integrated circuit part number and package type are used herein solely for the illustration purposes and shall not be viewed as limiting the present invention in any way. A number of other integrated circuits in existence today can be used and said integrated circuits are available in a multitude of packaging options.

The majority of other electronic components required to complete the circuit of the Ethernet module 10 are mounted upon the second side 102. Also mounted upon the second side 102 is the connector 303. Said connector 303 comprises a plurality of pins or leads 16 that are used to mount the Ethernet module 10 on the host circuit board (not shown) and conduct electric signals between the Ethernet module 10 and the host circuit board. Said pins or leads 16 are positioned in a generally parallel fashion with respect to the circuit board 100, and in a generally perpendicular fashion to the host circuit board.

The connector 303 is designed for surface mounting on the second side 102 of the circuit board 100. The plastic part 304 of the connector 303 is designed in such a way, and the whole connector 303 is positioned on the circuit board 100 in such a fashion as to allow the plastic part 304 reside completely within the boundaries of the circuit board 100. This minimizes the overall height 301 of the circuit board 100.

It must be noted that the Ethernet module according to the preferred embodiment of the present invention may comprise an enclosure (not shown). Such an enclosure can be made of plastic, stamped out of sheet metal, or manufactured in some other suitable way.

The primary function of the enclosure may be to serve as a Faraday shield, function as a heat sink for the circuit board and components thereof, or simply exist for decorative purposes. Said enclosure may envelope the circuit board 100 completely or only partially cover said circuit board. All such variations are within the scope and the spirit of the present invention.

Looking now at FIG. 5, there shown a host circuit board 400, a “standard” RJ connector jack 17, and the Ethernet module 10 according to the preferred embodiment of the present invention, said Ethernet module 10 mounted behind said RJ connector jack 17.

Those skilled in the art will immediately appreciate that the Ethernet module 10 built according to the preferred embodiment of the present invention minimizes its footprint on the host circuit board 400, while taking advantage of the empty space available behind the RJ connector jack 17. The height 301 and width 302 of the Ethernet module 10 correspond closely to the height 211 and width 212 of the RJ connector jack 17.

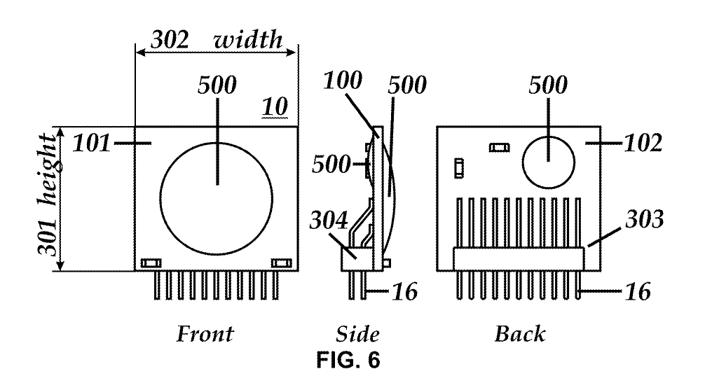

Looking now at FIG. 6, there shown a front, side, and back views of the Ethernet module according to the alternative embodiment of the present invention.

In the alternative embodiment of the present invention, the Ethernet module 10 does not use an integrated circuit 300. In the alternative embodiment of the present invention, the Ethernet module 10 utilizes chip-on-board technology to mount one or more encapsulated silicon dies 500 upon the first side 101 and, if necessary, the second side 102 of the circuit board 100.

Those skilled in the art will recognize that the use of the chip-on-board technology will allow to further reduce the cost and size of the Ethernet module 10.

It should be noted that the number of silicon dies used, their position on the circuit board 100, number of dies encapsulated together, as well as the shape and material used for the die encapsulation may vary widely and the particular die arrangement presented on FIG. 6. should not be viewed as limiting the scope of the present invention in any way.

While the invention has been described in terms of what is presently considered to be the most practical and preferred embodiment, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An Ethernet module for a finished Ethernet device, said finished Ethernet device comprising: a host circuit board, and a connector jack mounted upon said host circuit board; wherein said Ethernet module comprises a circuit board vertically mountable upon the host circuit board, and wherein said Ethernet module is dimensioned to correspond to a rear face of said connector jack.

2. The Ethernet module according to claim 1, wherein said Ethernet module is dimensioned to have a height and a width substantially equal to the respective height and width of said connector jack.

3. The Ethernet module according to claim 1, wherein said Ethernet module is dimensioned to have a height and a width smaller than the respective height and width of said connector jack.

4. The Ethernet module according to claim 1, wherein said Ethernet module is dimensioned to have a height and a width larger than the respective height and width of said connector jack without substantially increasing the height and width of said finished Ethernet device.

5. The Ethernet module according to claim 1 further comprising an integrated circuit (IC), wherein said integrated circuit comprises a central processing unit (CPU) or a microcontroller.

6. The Ethernet module according to claim 5, wherein said integrated circuit further comprises an Ethernet controller.

7. The Ethernet module according to claim 6, wherein said integrated circuit further comprises a universal asynchronous receiver and transmitter (UART).

8. The Ethernet module according to claim 1 further comprising one or more silicon dies mounted upon said circuit board.

9. The Ethernet module according to claim 1, wherein said circuit board is at least partially covered with an enclosure.

10. The Ethernet module according to claim 1, wherein said circuit board is dimensioned to have a height and a width substantially equal to the respective height and width of said connector jack.

11. The Ethernet module according to claim 1, wherein said circuit board is dimensioned to have a height and a width smaller than the respective height and width of said connector jack.

12. The Ethernet module according to claim 1, wherein said circuit board is dimensioned to have a height and a width larger than the respective height and width of said connector jack without substantially increasing the height and the width of said finished Ethernet device.
